(19) United States
(12) Patent Application Publication
(10) Pub. No.: US 2009/0044112 A1
(43) Pub. Date: Feb. 12, 2009

(54) Animated Digital Assistant

(75) Inventors: Umberto BASSO, Treviso (IT); Fabio SALVADORI, Varago (IT)

Correspondence Address: GREENBERG TRAURIG, LLP (SV);IP DOCKETING, 2450 COLORADO AVENUE, SUITE 400E, SANTA MONICA, CA, 90404, US

(73) Assignee: H-CARE SRL, Treviso (IT)

(21) Appl. No.: 11/836,750

(22) Filed: Aug. 9, 2007

(51) Int. Cl. G06F 3/048

(52) U.S. Cl. 715/706

(57) ABSTRACT

A method for interacting with a user comprising: receiving an input on a device, determining a text-based response based on the input using a logic engine, generating an audio stream of a voice-synthesized response based on the text-based response, rendering a video stream using a morphing of predetermined shapes based on phonemes in the voice-synthesized response, the video stream comprising an animated head speaking the voice-synthesized response, synchronizing the video stream and the audio stream, transmitting the video stream and the audio stream over the network; and presenting the video stream and the audio stream on the device.

### BACKGROUND

1. Field of the Invention

This invention relates generally to the field of a user interface. More particularly, the invention relates to a method and apparatus for interacting with a user using an animated digital assistant.

2. Description of the Related Art

Animated characters are presented on displays in various applications such as assistance in computer-based tasks including online customer service and online sales. These animated characters can present some information in a more user-friendly way than text-based interaction alone.

However, these animated characters are generally simplistic in form. In many cases, they are similar to primitive cartoon characters. Such animations limit the capacity for the animated character to interact with a user in a way that creates an emotional reaction by the user. Emotional reactions can be helpful in improving customer satisfaction levels in an online customer service operation or increasing sales and customer satisfaction in an online sales operation. What is needed is a system and method for animated characters to be more realistic.

In some cases, one of several pregenerated animation sequences may be presented to the user in response to simple queries. This simple interaction does not allow for more sophisticated, personalized interactions that might be handled by a customer service or sales operation. What is needed is a system and method for animated characters to respond to more complex user inquiries. What is needed is a system and method for animated characters to respond to user inquiries in a personalized way.

### SUMMARY

A method for interacting with a user comprising: receiving an input on a device, determining a text-based response based on the input using a logic engine, generating an audio stream of a voice-synthesized response based on the text-based response, rendering a video stream using a morphing of predetermined shapes based on phonemes in the voice-synthesized response, the video stream comprising an animated head speaking the voice-synthesized response, synchronizing the video stream and the audio stream, transmitting the video stream and the audio stream over the network; and presenting the video stream and the audio stream on the device.

### BRIEF DESCRIPTION OF THE DRAWINGS

These and other features, aspects, and advantages of the present invention will become better understood with regard to the following description, appended claims, and accompanying drawings where:

FIG. 1 is a flow chart of one embodiment of a method of generating an animated digital assistant.

FIG. 2 is a block diagram of one embodiment of a system for generating an animated digital assistant client.

FIG. 3 is a block diagram of one embodiment of an animated digital assistant client of the present invention.

FIG. 4 is a block diagram of one embodiment of an apparatus for generating the video stream for a dynamic face engine.

FIG. 5 is a block diagram of one process flow of a three-dimensional rendering process.

FIG. 6 is a block diagram of a system for generating an animated digital assistant according to one embodiment.

FIG. 7 is a diagrammatic representation of a machine of the present invention in the exemplary form of a computer system.

### DETAILED DESCRIPTION OF PREFERRED EMBODIMENTS

At least some embodiments of the disclosure relate to a method and system for generating an animated digital assistant.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, an animated digital assistant server services several computers over the internet. Each computer has a browser displaying a web page having a frame served by a service applications server and a frame containing an animated digital assistant client served by the animated digital assistant server. The service applications server may serve web pages related to a customer service or sales function, for example.

Each animated digital assistant client has a video player containing an animated head with lip movements synchronized with an audio stream that includes voice-synthesized speech. The digital assistant client also has video player controls, a menu for user-input, and a display area configurable with hypertext markup language (HTML) and cascading style sheets (CSS). The digital assistant client receives input that is transmitted to the animated digital assistant server and processed using a rules-based system to generate a text-based response. A voice synthesis process and dynamic face engine are used to generate an animated head with lip movements synchronized to the voice-synthesized response. Other features of the animated head, such as the eyebrows and eyelids, are also generated to move in way that is consistent with the voice-synthesized response.

The animated digital assistant can provide a more human-like user interaction in the context of the associated web pages served by the service applications server. In some cases, the improved interaction may lead to higher customer satisfaction levels and more sales. Furthermore, the automated service may cost less than a live online chat or other service in which a human operator interacts with the user.

In one embodiment, addition of an animated digital assistant client to an existing service applications service does not involve integration with the service applications server. This can simplify upgrade of existing systems to include an animated digital assistant. However, some communication means can be inserted into the web pages of a service applications server to allow communication with a face player client.

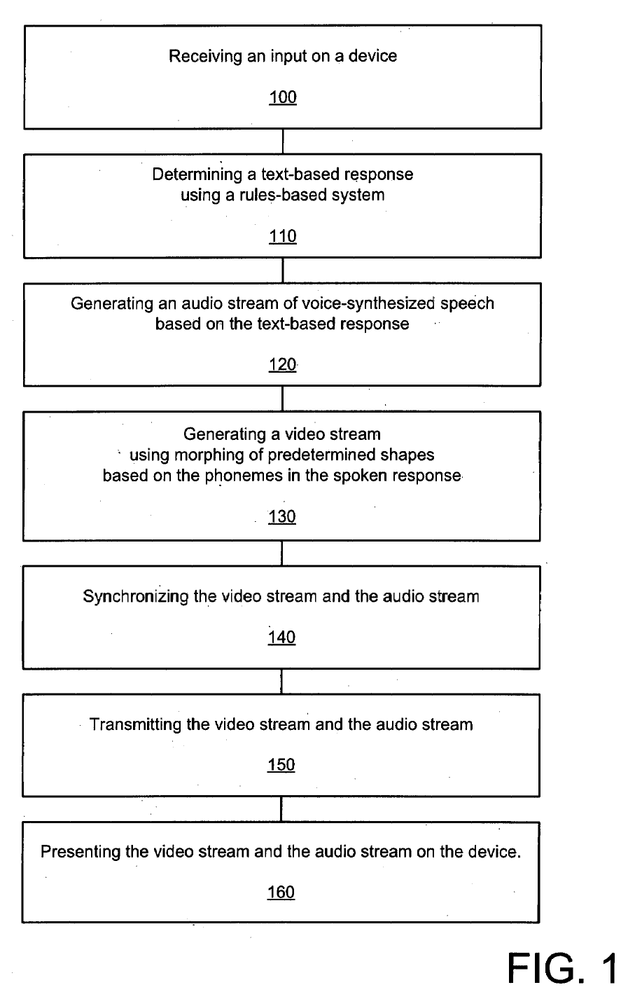

FIG. 1 illustrates one embodiment of a method for generating an animated digital assistant of the present invention.

In step 100, an input is received on a device.

In one embodiment, the device is a personal computer configured to access the internet through a browser. In another embodiment, the device is a mobile phone configured to access a network through a browser. In yet another embodiment, the device is a personal digital assistant. In other embodiments, an animated digital assistant may be implemented in a household appliance, car dashboard computer, or other devices capable of implementing a method of the present invention.

Input may be received from a user of the device using a keyboard, a cursor control device (mouse), microphone, and/or touch-sensitive screen, for example. Input may also be received from the device through a user-initiated or automated process. Examples include input that is retrieved from a memory on the device and input that is collected by sensors accessed by the device.

The input can be received by a server over the internet or a local area network, for example. The input can include one or more types of information. For example, the input can include a user identity. The user identity may be a user name for the user of the device. The input can also include a universal resource locator (URL) of the page being displayed on the device. The URL can be used to identify what the user is viewing so that the behavior of the animated digital assistant can be influenced accordingly. The input can also include session data from a session process on the user device. The session data can be used by the server to distinguish between several devices when concurrently interacting with more than one device. The input can include other types of information.

The input can be received in many formats. In some cases, the input includes a selected menu choice from a menu presented on the user device. In some cases, other forms of input may be received directly by the face player client, including text-based entry through a keyboard, speech recognition input through a microphone, or links clicked using a mouse. The input can also be received during page loading. In one embodiment, a JavaScript framework is inserted into web pages to enable interaction with the face player client. The JavaScript framework searches for specific meta tags in the page header during page loading. When any of the specific meta tags are found, an event is sent to the face player client. Activation points can be textual or image links that call a JavaScript function to send an event to the face player client. The meta tags and activation points can be inserted into the web pages on a service applications server to allow it to communicate with the face player client.

In step 110, a text-based response is determined using a rules-based system.

A rules-based system applies a set of rules to a set of assertions to determine a response. The rules can be a collection of if-then-else statements. In some cases, more than one rule may have its conditions satisfied (“conflict set”). In some cases, the conflict set is determined by selecting the subset of if-then-else statements in which the conditions are satisfied. In other cases, a goal is specified and the subset of if-then-else statements in which the actions achieve the goal are selected. In some cases, an information tree is used to determine one or more applicable rules in the conflict set.

Various methods may be used to select which rule in the conflict set to use. For example, the selected rule may be the first-applicable rule, the most-specific rule, the least-recently-used rule, the best rule based on rule weightings, or a random rule.

The assertions can include input data such as the session data from the session process on the user device, a URL, and/or events received from the page using meta tags or activation points. Furthermore, the assertions can include facts retrieved from a database coupled to the server. The user identity can be used to access an associated customer record in a database. The facts in the customer record can include, for example, name, address and previous transactions for that user.

The assertions can also include data received from external systems. For example the server may interface with legacy systems, such as customer relationship management (CRM) systems, trouble ticket systems, document management systems, electronic billing systems, interactive voice response (IVR) systems, and computer telephony integration (CTI) systems. Some input data, such as user identification, may be passed to the legacy system to select associated data or otherwise determine assertions to be passed from the legacy system to the rules-based system.

In response to the application of the rules, a text-based response is generated. In some cases, the text-based response is dynamically generated by the rules-based system. Furthermore, the text-based response may include input data or information retrieved from the database coupled to the server or an external system. For example, the text-based response may incorporate the name and bank balance of the user as retrieved from the customer database using a user identity.

In some cases, other responses can be generated instead of or in addition to the text-based response. For example, the rules-based system may generate a new URL to be loaded by the service applications server, a new menu to be presented to the user in the face player client or new content to be presented in the display area of the face player client. The face player client performs these actions by generating call actions. JavaScript messages and Flash messages may be used to communicate between web pages on a service applications server and the face player client.

The rules-based system is one type of a logic engine. In other embodiments, the text-based response may be determined by another type of logic engine, such as an artificial intelligence system, a neural network, a natural language processor, an expert system, or a knowledge-based system.

In step 120, an audio stream is generated. In one embodiment, text-to-speech conversion is performed on the text-based response to produce a voice-synthesized response. The voice-synthesized response is encoded to produce an audio stream. In one embodiment, the text-to-speech conversion process also identifies a sequence of phonemes used in the text-to-speech conversion process.

In step 130, a video stream is generated by rendering three-dimensional video and encoding the rendered frames. In one embodiment, the rendering is performed by morphing a set of predetermined shapes based on the phoneme sequence to produce a sequence of output shapes and rendering the sequence of output shapes to generate a video stream.

In one embodiment, the predetermined shapes are specified at least in part by a set of three-dimensional vertices. Each vertex specifies a spatial orientation of a particular point of the head. Each of these particular points correspond to the same point of the head across the set of predetermined shapes. For example, each of a set of points may indicate the spatial orientation of the tip of the nose for the corresponding one of the predetermined shapes. In one embodiment, the output shapes have vertices that include coordinates that are the weighted average of the vertex coordinates among the selected predetermined shapes. In one embodiment, the weights are determined at least in part by the phoneme sequence. Other methods of morphing may be used.

In step 140, the audio stream and video stream are synchronized so that the mouth movements are synchronized with the voice-synthesized response.

In step 150, the video stream and the audio stream and transmitted. In one embodiment, the video and audio streams are transmitted over the internet. In other embodiments, the video and audio streams are transmitted over a local area network (LAN) or wireless network.

In a preferred embodiment, the video stream and audio stream are transmitted using Flash Media Server 2. By utilizing the streaming server as a proxy in the communication channel between the animated digital assistant server and face player client, synchronization can be facilitated and response time can be improved.

In step 160, the videos stream and the audio stream are presented on the device. In a preferred embodiment, the video stream and audio stream is presented using Flash browser plug-in. The use of a widely-distributed plug-in allows the video and audio to be presented without dedicated software.

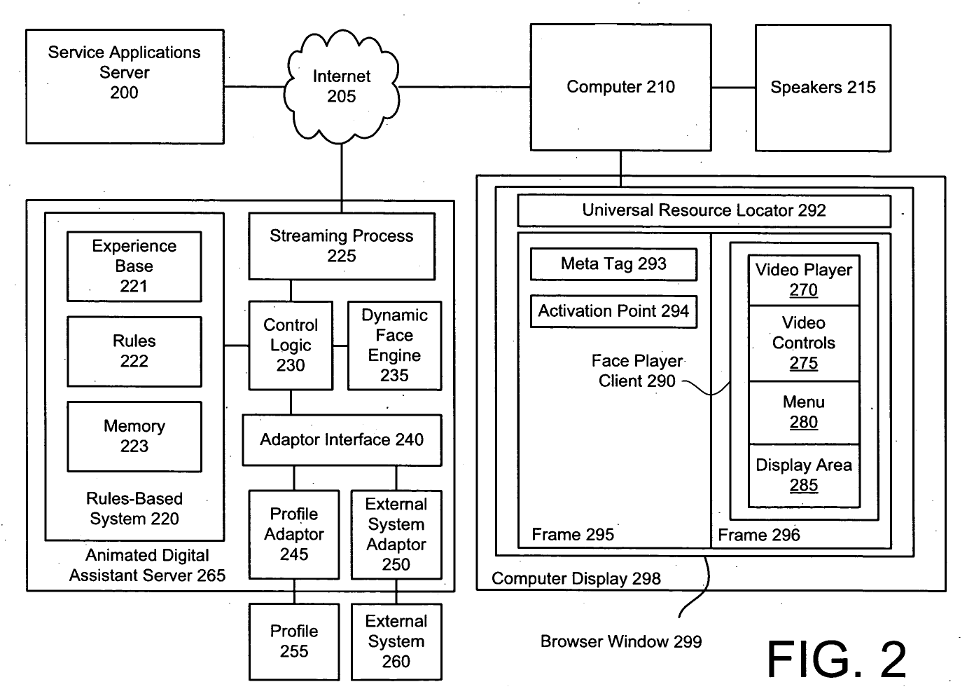

FIG. 2 illustrates a block diagram of a system of the present invention according to one embodiment of the invention.

A computer 210 is connected over the internet 205 to a service applications server 200 and an animated digital assistant server 265. The computer is connected to a computer display 298 and a set of speakers 215. In one embodiment, the computer 210 uses a browser to display a browser window 299 on the display 298 and a Flash browser plug-in to present video streams to the user. The computer uses the speakers 215 to generate audio to present audio streams to the user.

In one embodiment, the face player client 290 cannot be loaded as a standard web page because persistence of the client-server connection is mandatory to maintain the user session and allow the face player client 290 to respond to user requests. In one embodiment, the computer 210 uses a browser to display a frame 295 and a frame 296. A frame 296 is used to be always active while the frame 295 is serviced by the service applications server 200.

In one embodiment, the frame 295 contains HTML and CSS served by the service applications server 200. A universal resource locator (URL) 292 is displayed to present the URL of the web page in the frame 295. This can be the web pages served by the service applications server 200. In some cases, the web pages served by the service applications server 200 are identical to those generated before an animated digital assistant server was installed. In other cases, the frame 295 contains includes modifications to communicate with the face player client 290.

In some cases, a meta tag 293 is incorporated into the web page to transmit an event to the face player client 290 when a JavaScript framework detects the meta tag 293 during a page load. Different meta tags can be included in various pages to communicate in different ways to the face player client 290. In other cases, an activation point 294 is inserted into text and/or image links in the frame 295. The activation point 294 has a link that includes JavaScript code to send an event to the face player client 290 when, for example, the link is clicked or the cursor passes over the link. Different activation points may be inserted into various web pages to communicate with the face player client 290 in different ways.

In some embodiments, the face player client 290 is embedded into a container with the frame 296. In one embodiment, the face player client 290 contains four components: a video player 270, video controls 275, a menu 280 and a display area 285. The content of the frame 296 is driven by the animated digital assistant server 265 and the content of the frame 295 is created by interaction with the service applications server 200. The independence of the animated digital assistant server 265 and the service applications server 200 can facilitate the addition of a face player capability into an existing service applications environment.

The menu 280 presents several menu choices for the user. In a preferred embodiment, each menu choice is a button containing one line of text. Multi-line text may be used. In one embodiment, four menu choices are provided. In other embodiments, more or less menu choices may be provided. A menu choice can be selected by using a mouse to click on one of the menu choices. Other methods of selecting a menu choice may be used.

The display area 285 can contain HTML-based text customizable using CSS and HTML. The display area 285 can also be used to add functionality to the client. For example, promotions or other advertising could be inserted into the display area 285 using images or flash. JavaScript can also be used in the display area 285 to improve user interaction. Input is received by the face player client 290 through the menu, a meta tag detected during a page load in the frame 295, or an activation point that is clicked, for example, in the frame 295. Other interactions with the activation point may trigger an input event, such as passing the mouse over the link. The input is sent by the computer 210 through the internet 205 to the animated digital assistant server 265. The animated digital assistant server 265 includes a control logic 230 coupled to a streaming process 225 for sending output, including video and audio streams, to the computer 210 and receiving input from the computer 210.

The control logic 230 is also coupled to an adapter interface 240 for interfacing with a profile adapter 245 that interfaces with a profile 255 and an external system adapter 250 that interfaces with an external system 260.

The external system 260 may be a legacy system, such as CRM system, trouble ticket system, document management system, electronic billing system, IVR system, or CTI system. Some input data, such as user identification, may be passed to the legacy system to select associated data or otherwise determine input to be passed from the legacy system to the rules-based system. In one embodiment, additional external system adaptors may be coupled to the adapter interface 240 through external system adaptors to connect with additional external systems. The profile 255 includes information to manage the interface between the one or more external systems and the animated digital assistant server 265.

The control logic 230 is coupled to a rules-based system 220 comprising an experience base 221, rules 222, and a memory 223. In one embodiment, the experience base 221 includes the rules 222 and an information tree used to define the relationship between the rules 222. The memory includes input data from the face player client 290 and input received through the adaptor interface 240 from one or more external systems. The rules-based system is one type of a logic engine. In other embodiments, the text-based response may be determined by another type of logic engine, such as an artificial intelligence system, a neural network, a natural language processor, an expert system, or a knowledge-based system.

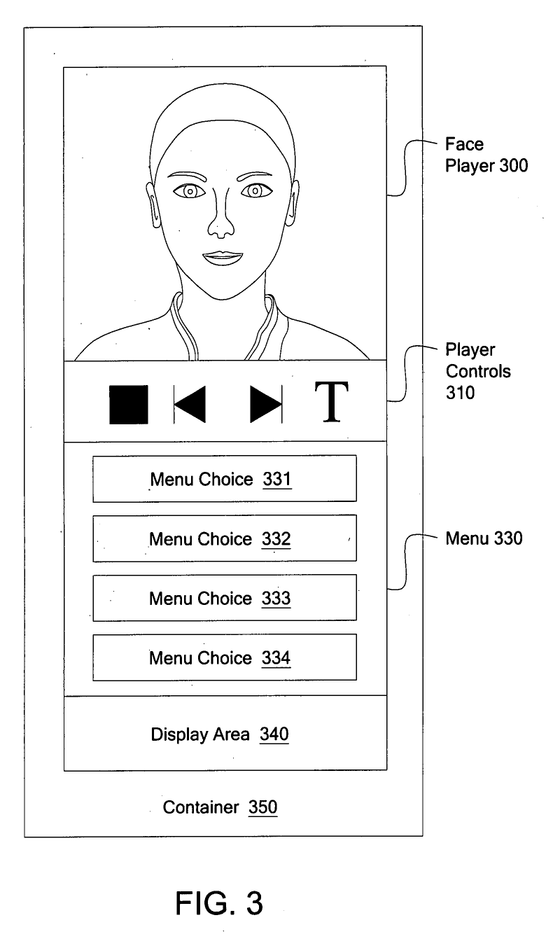

FIG. 3 shows a block diagram of a face player client 350. The face player client 350 includes a face player 300, player controls 310, a menu 330, and a display area 340.

The components of the face player client 350 are illustrated in a vertical arrangement. In one embodiment, each component can be adjusted in terms of size and layout. In some cases, each component is configurable in terms of functionality and interaction with the user. For example, certain buttons in the player controls 310 might be disabled to limit some functionality, such as skipping. And the functionality of the menu 330 might be changed to perform a tracing function in a page when a user chooses one of the menu selections.

In a preferred embodiment, the video player 300 is a flash object. In one embodiment, the component is about 140 pixels wide and 160 pixels tall. However, other formats may be used. Smaller video sizes may diminish the visual experience for the user. Larger video sizes require increased bandwidth in the communication channel between the animated digital assistant server and the face player client. Larger video sizes also require a larger portion of the graphics card memory and more computational resources for rendering. In one embodiment, the video player 300 manages the connection with the animated digital assistant server and is the proxy for the communication for all the components of the video player client 350.

In a preferred embodiment, the video player 300 presents an animated digital assistant that depicts a higher-quality image of a realistic looking character. In other embodiments, the video player 300 presents an animated digital assistant that depicts a lower-quality image of a cartoon-like character. It will be apparent to one skilled in the art that the level of realism will depend on many factors including, for example, bandwidth available in the communications channel and available rendering performance allocated for each face player client concurrently served by the animated digital assistant server.

The video controls 310 are used to control the video player 300. In one embodiment, four button icons are used including a button to stop the video, rewind the video, fast forward the video and switch between video and text mode. Text mode disables the video and shows a readable version of the speech-synthesized content.

The menu 330 presents a menu choice 331, a menu choice 332, a menu choice 333 and a menu choice 334. In a preferred embodiment, each menu choice is a button containing one line of text. In other embodiments, multi-line text may be used. In the illustrated embodiment, four menu choices are provided. However, more or less menu choices may be provided. A menu choice can be selected by using a mouse to click on one of the menu choices. Other methods of selecting a menu choice may be used, such as speech recognition or touch-sensitive displays.

The display area 285 can contain HTML-based text customizable using CSS and HTML. The display area 285 can also be used to add functionality to the client.]

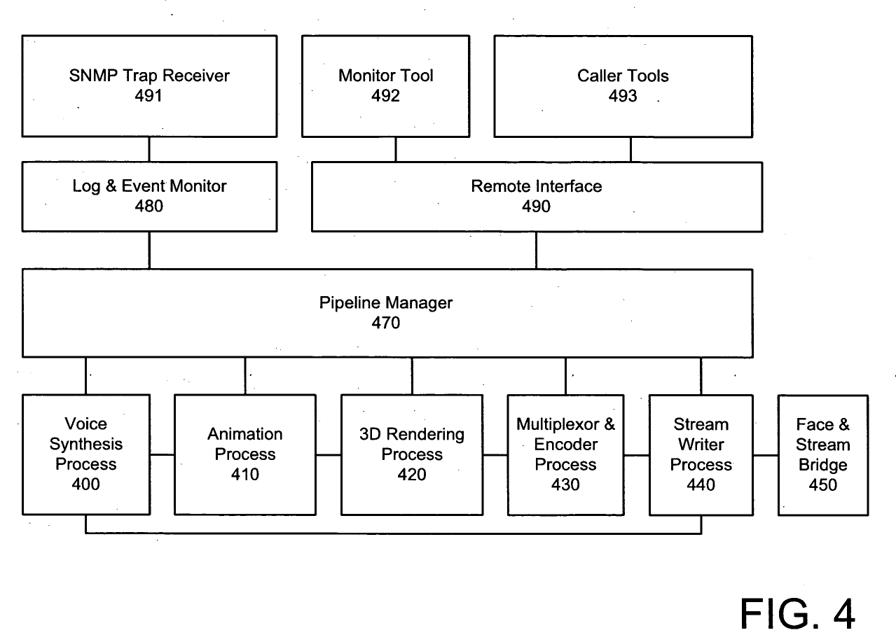

FIG. 4 shows a block diagram of a dynamic face engine of the present invention.

A pipeline manager 470 manages a pipeline through a voice-synthesis process 400, an animation process 410, a three dimensional (3D) rendering process 420, a multiplexer-and-encoder process 430, and a stream-writer process 440. The pipeline may be concurrently processing text-based responses from the rules-based system for multiple face player clients. Furthermore, the pipeline can be concurrently processing different frames in a frame sequence for a particular face player client in different stages of the pipeline. Other methods may be used to manage the process to perform more efficiently.

A voice-synthesis process 400 receives the text-based response from the rules-based system and performs voice synthesis to generate a voice-synthesized response corresponding to the text-based response. In one embodiment, commercial voice-synthesis programs can be integrated in the system to perform this process step. For example, Loquendo's Text-To-Speech (TTS) software may be used. The voice-synthesized response is passed to a stream writer 450. In one embodiment, the voice-synthesis process generates phoneme data indicating the sequence of phonemes used to generate the voice-synthesized response. The phoneme data is passed to an animation process 400. In some embodiments, multiple face player clients are being concurrently served.

An animation process 410 receives the phoneme data and uses the phoneme data to generate a sequence of shapes in the form of three-dimensional vertices.

In one embodiment, each phoneme is used to access a sequence of arrays in which each array is used to generate a frame in the video sequence for that phoneme. Each element of the array includes a weight assigned to a corresponding one of the predetermined shapes to be mixed for that frame.

In one embodiment, the predetermined shapes are specified at least in part by a set of three-dimensional vertices. Each vertex specifies a spatial orientation of a particular point of the head. Each of these particular points correspond to the same point of the head across the set of predetermined shapes. For example, each of a set of points may indicate the spatial orientation of a corner of the mouth for the corresponding one of the predetermined shapes. In one embodiment, the output shapes have vertices that include coordinates that are the weighted average of the vertex coordinates among the selected predetermined shapes. In one embodiment, the weights are determined at least in part by the phoneme sequence. Other methods of morphing may be used.

In some cases, the selection of movements may also be made based on the sequence of phonemes to make facial expressions consistent with the content of the speech. In other cases, other factors may be used to select one of several possible movement sequences. For example, the selection of a sequence of arrays may also be based on the context of the discussion in terms of the emotion to be conveyed. In some cases, eye blinking may be inserted randomly based on a target blinking rate.

The morphing may also be configured such that other aspects of the facial image, such as eyebrows, move naturally in synchronization with the lip movements, the sequence of phonemes and the context of the voice-synthesized response.

The 3D output shapes are then passed to a 3D rendering process 430.

The 3D rendering process 430 renders the sequence of 3D output shapes produced into a sequence of two-dimensional frames. This process is computationally intensive and can be a limiting factor in the dynamic face generation process especially as the number of face player clients concurrently served increases. In a preferred embodiment, one or more graphics cards are used to assist the central processing unit in the rendering of the three-dimensional images.

In some cases, the transfer of rendered frames between the memory for the graphics processing unit (GPU) and the memory for the central processing unit (CPU) is inefficient in that transferring a frame in a portion of the GPU memory is not proportionally faster than transferring a larger portion of the GPU memory. In a preferred embodiment, overall performance is improved by rendering blocks of several frames and storing each frame in separate portions of the graphics card memory. In one embodiment, each frame corresponds to one of several face player clients being served concurrently. A single transfer between the graphics card and CPU memory for each block of frames reduces the number of transfers required for a given number of rendered frames. The number of frames that can be transferred in a single transfer operation depends on several factors, including the size of each frame, the size of the graphics card memory, the number of concurrent face player clients served, and the time for the graphics card to render each frame in relation to the frame rate desired in the streaming video.

In one embodiment, the rendered video is in Red Green Blue Alpha (RGBA) format and the CPU converts this to YUV format prior to encoding. YUV format takes advantage of models of human sensitivity to color and is used by encoding algorithms.

The multiplexer-and-encoder process 430 receives the output of the 3D rendering 420 and generates separate streams for each of the multiple face player clients that are being concurrently served. In one embodiment, multiple frames are processed by the GPU for each transfer from the GPU memory to the CPU memory and each frame corresponds to a different face player client. In one embodiment, the multiplexer-and-encoder process performs frame reordering if any frames were received out of sequence.

The multiplexer-and-encoder process 430 also encodes the sequence of frames. In one embodiment, encoding is performed using a Flash Media Encoder. In other embodiments, encoding is performed using the Motion Pictures Experts Group 4 (MPEG-4) standard. However, other methods of encoding may be used.

The stream-writer process 440 receives the encoded video for each of the face player clients and generates a video stream. The stream-writer process 440 also receives the voice-synthesized response from the voice-synthesis process 400 and generates an audio stream. The video and audio streams are synchronized so that when the video and audio stream is played on the face player client, the animation and speech are synchronized.

A face-and-stream bridge 450 receives the video stream and audio stream for each of the face player clients and interfaces with one or more face stream engines to stream the video and audio streams over the internet to the corresponding face player client. In one embodiment, the allocation of streams among multiple face stream engines is based on load balancing methods.

In one embodiment, the pipeline manager 470 interfaces with a log-and-event monitor 480 to an simple network management protocol (SNMP) trap receiver 491. The log-and-event monitor 480 can log errors into a file for troubleshooting purposes, for example.

In one embodiment, the pipeline manager 470 interfaces with a remote interface 490 to a monitor tool 492 and caller tools 493. This monitor tool 492 logs events to be analyzed for performance improvement, for example. Information tracked can include the number of concurrent videos being generated, average video generation performance and last video generation performance in terms of generation time, frames generated per second and bytes generated per second. This information can be used to verify application status, manage load distribution, and highlight critical performance issues, for example.

The caller tools 493 interface with the animated digital assistant control logic to receive requests for generating a face player client video. In one embodiment, the authoring tool interfaces through the caller tools 493 to request that a face player client video be generated.

The rules-based system is one type of a logic engine shown in this illustrated embodiment. In other embodiments, the text-based response may be determined by another type of logic engine, such as an artificial intelligence system, a neural network, a natural language processor, an expert system, or a knowledge-based system.

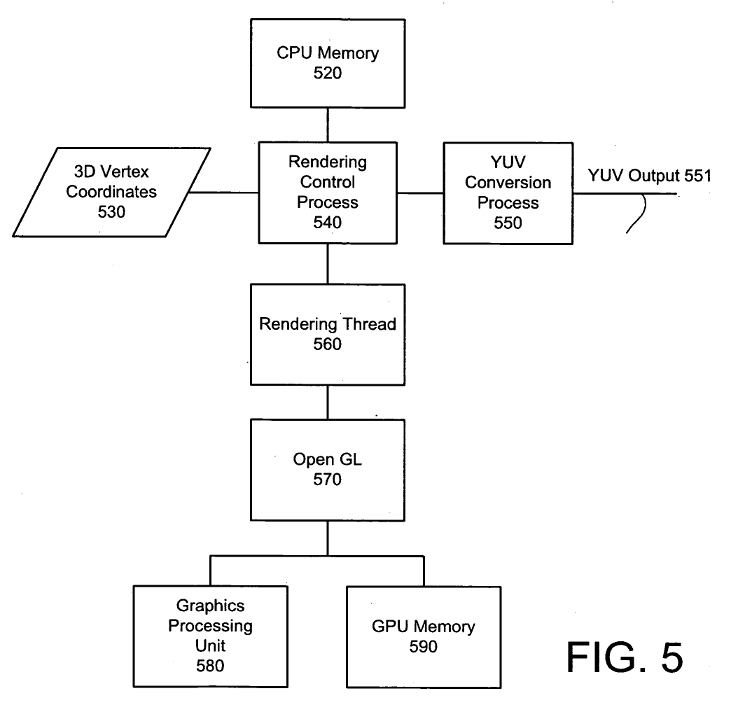

FIG. 5 shows a block diagram of a 3D rendering apparatus of the present invention. The rendering process is computationally intensive and can be a limiting factor in the dynamic face generation process especially as the number of face player clients concurrently served increases. In a preferred embodiment, one or more graphics cards are used to assist the central processing unit in the rendering of the three-dimensional images.

A rendering control process 540 receives 3D vertex coordinates 530. In one embodiment, the 3D vertex coordinates 530 may be one or more output shapes in a sequence of output shapes generated in response to a sequence of phonemes as described herein. Furthermore, the 3D vertex coordinates may be output shapes corresponding to several face player clients being processed concurrently.

The rendering control process 540 manages the rendering process. The rendering process transforms each sequence of output shapes into a sequence of two-dimensional frames. In some cases, multiple sequences of output shapes are interleaved to generate multiple two dimensional frames. Each of the interleaved sequences of output shapes correspond to one of several face player clients being served concurrently.

In some embodiments, the rendering control process 540 transfers output shapes and receives rendered frames by transfers between a central processing unit (CPU) memory 520 and a graphics processing unit (GPU) memory 590. A rendering thread 560 interfaces with the GPU 580 and a GPU memory 590 through an open graphics library (open GL) 570. The GPU 580 renders the output shapes to produce frames in the GPU memory 590. In one embodiment, multiple rendering threads are created in the GPU 580. In a preferred embodiment, the rendering threads are managed across more than one GPU.

In one embodiment, the transfers between the CPU memory 520 and the GPU memory 590 are inefficient in that transfers of smaller portions of GPU memory 580 to the CPU memory 520 are not proportionally faster than transfers of larger portions of GPU memory 590 to the CPU memory 520. In a preferred embodiment, overall performance is improved by rendering several frames and storing each frame in separate portions of the GPU memory 590. In one embodiment, each frame corresponds to one of several face player clients being served concurrently. A single transfer between the graphics card and CPU memory is used to transfer multiple frames stored in different portions of the GPU memory. The impact of the inefficient transfer is reduced by reducing the number of transfers required for a given number of rendered frames. The number of frames that can be transferred in a single transfer operation depends on several factors, including the size of each frame, the size of the graphics card memory, the number of concurrent face player clients served, and the time for the graphics card to render each frame in relation to the frame rate desired in the streaming video.

A YUV conversion process 560 receives the rendered video in Red Green Blue Alpha (RGBA) format and the CPU converts it to a YUV output 551. The YUV output 551 is in YUV format. In one embodiment, the YUV output 551 is used in an encoding process to generate streaming video. Other formats may be used for encoding.

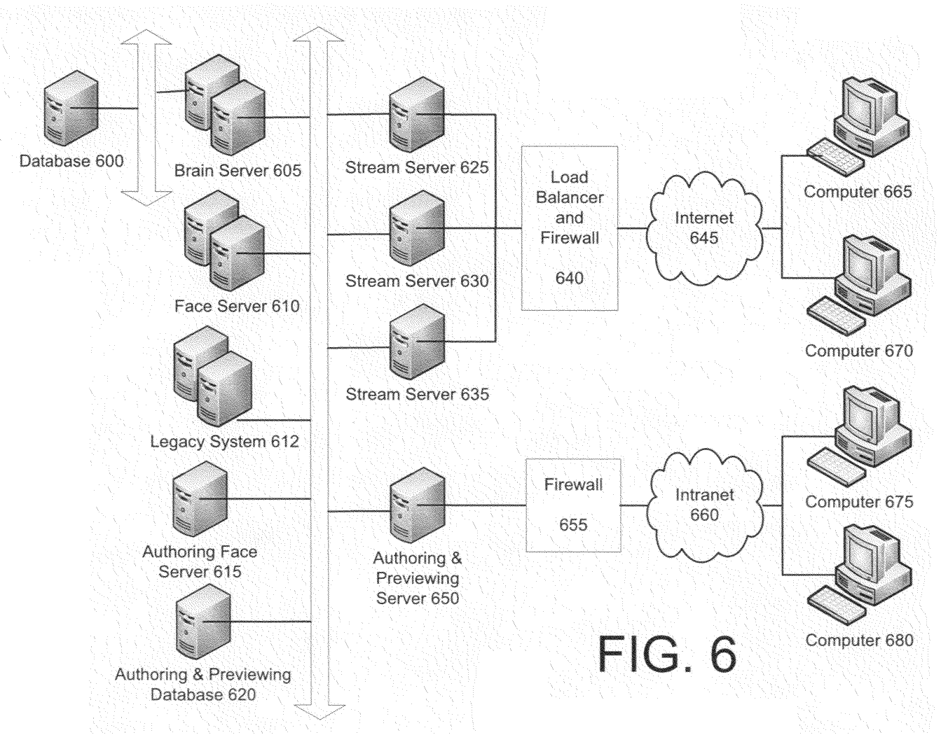

FIG. 6 shows a block diagram of a system of the present invention. A computer 665 and a computer 670 are connected to a load balancer/firewall 640 through the internet 645. Each computer may be running a face player client. Two computers are shown for illustration purposes, but more or less computers may be coupled to the load balancer/firewall 640.

The load balancer/firewall 645 manages the load among the stream server 625, the stream server 630 and the stream server 635. Three stream servers are shown for illustration purposes, but more of less stream servers may be used depending on the potential concurrent user load to be managed, for example.

The brain server 605 includes the control logic that manages the input data received from the face player clients through one of the stream servers, the input from legacy systems received through the adaptor interface, and the experience base stored in a database 400. In one embodiment, the experience base contains an information tree and the rules to be applied in the rules-based system. In another embodiment, the experience base contains information used to implement another type of logic engine.

For example, the server may interface with a legacy system 612. The legacy system 612 may be a customer relationship management (CRM) system, a trouble ticket system, a document management system, an electronic billing system, an interactive voice response (IVR) system, or a computer telephony integration (CTI) system, for example. Some input data, such as user identification, may be passed to the legacy system 612 to select associated data or otherwise determine assertions to be passed from the legacy system 612 to the brain server 605. More than one legacy system may be used.

In one embodiment, the face server 610 includes a dynamic face engine that receives the text-based response from the rules-based server and generates a video stream and an audio stream according to methods described herein. The video and audio stream is transmitted through the stream server allocated to the communication channel between the stream server and the corresponding face player client.

Other output of the rules based system may be delivered in the same communication channel as the audio and video stream. For example, the output may include a new URL to be loaded by the browser, a new menu to display in the menu area of the face player client and/or new content to display in the display area of the face player client.

This figure does not show a service applications server. In a preferred embodiment, a service applications server is coupled to the internet to serve the computer 465 and the computer 470 according to methods described herein.

In one embodiment, an authoring system is included. The authoring system is used to develop and test a configuration before releasing it for use by end users. For example, the rules-based system, including rules, text-based responses and actions, may be defined using an authoring system.

A computer 675 and a computer 680 are coupled through the intranet 660 and a firewall 655 to an authoring-and-previewing server 650. The authoring-and-previewing-server 650 is coupled to an authoring face server 615 and an authoring-and-previewing database 620. The authoring face server 615 and an authoring-and-previewing database 620 provide much of the functionality of the methods described except that it is only meant to serve only a few users as it is meant for authoring and previewing only. Furthermore, the authoring-and-previewing server 650.

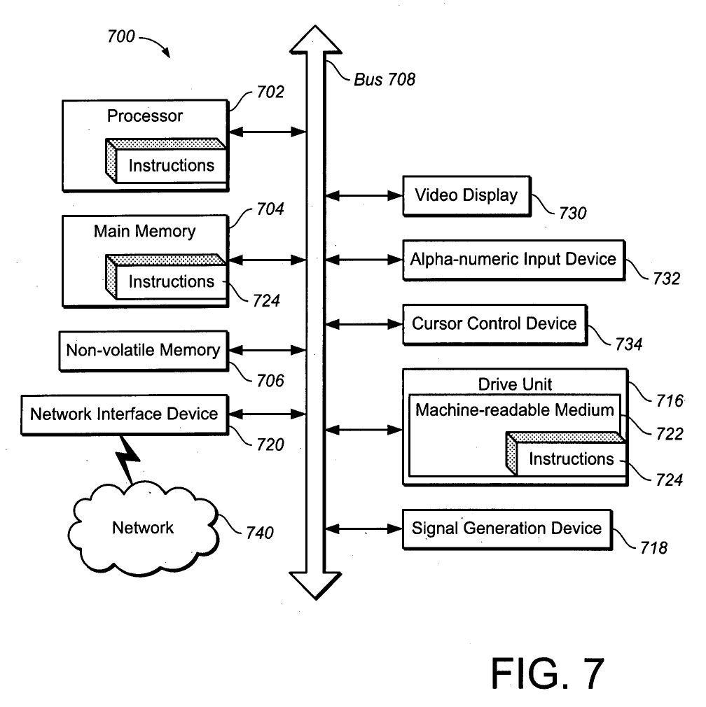

FIG. 7 shows a diagrammatic representation of a machine in the exemplary form of a computer system 700 within which a set of instructions, for causing the machine to perform any one or more of the methodologies discussed herein, may be executed. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 700 includes a processor 702 (e.g., a central processing unit (CPU) a graphics processing unit (GPU) or both), a main memory 704 and a nonvolatile memory 706, which communicate with each other via a bus 708. In some embodiments, the computer system 700 may be a laptop computer, personal digital assistant (PDA) or mobile phone, for example. The computer system 700 may further include a video display 730 (e.g., a liquid crystal display (LCD) or a cathode ray tube (CRT)). The computer system 700 also includes an alphanumeric input device 732 (e.g., a keyboard), a cursor control device 734 (e.g., a mouse), a disk drive unit 716, a signal generation device 718 (e.g., a speaker) and a network interface device 720. In one embodiment, the video display 730 includes a touch sensitive screen for user input. In one embodiment, the touch sensitive screen is used instead of a keyboard and mouse. The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 502 during execution thereof by the computer system 700, the main memory 704 and the processor 702 also constituting machine-readable media. The software 724 may further be transmitted or received over a network 740 via the network interface device 720.

In one embodiment, the computer system 700 is a server in a content presentation system. The content presentation system has one or more content presentation terminals coupled through the network 740 to the computer system 700. In another embodiment, the computer system 700 is a content presentation terminal in the content presentation system. The computer system 700 is coupled through the network 740 to a server.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for interacting with a user comprising:
receiving an input from a device;
determining a text-based response based on the input using a logic engine;
generating an audio stream of a voice-synthesized response based on the text-based response, the voice-synthesized response having a plurality of phonemes;
rendering a video stream based on the plurality of phonemes, the video stream comprising an animated head speaking the voice-synthesized response;
synchronizing the video and the audio;
transmitting the video stream and the audio stream over the network; and
presenting the video stream and the audio stream on the device.

2. The method of claim 1 wherein the step of rendering the video stream comprises morphing a plurality of predetermined shapes based on the plurality of phonemes.

3. The method of claim 1 wherein the input comprises a user identity.

4. The method of claim 1 wherein the input comprises a universal resource locator identifying the page displayed in a browser on the device.

5. The method of claim 1 wherein the user input comprises session data from a session process on the device.

6. The method of claim 1 further comprising:
transmitting a menu to the device, the menu comprising a plurality of choices; and
displaying the menu on the device; the input comprising a selection of at least one of the plurality of choices.

7. A machine-readable medium that provides instructions for a processor, which when executed by the processor cause the processor to perform a method for interacting with a user comprising:
receiving an input from a device;
determining a text-based response based on the input using a logic engine;
generating an audio stream of a voice-synthesized response based on the text-based response, the voice-synthesized response having a plurality of phonemes;
rendering a video stream based on the plurality of phonemes, the video stream comprising an animated head speaking the voice-synthesized response;
synchronizing the video stream and the audio stream;
transmitting the video stream and the audio stream over the network; and
presenting the video stream and the audio stream on the device.

8. The machine-readable of claim 7 wherein the step of rendering the video stream comprises morphing a plurality of predetermined shapes based on the plurality of phonemes.

9. The machine-readable of claim 7 wherein the input comprises a user identity.

10. The machine-readable of claim 7 wherein the input comprises a universal resource locator identifying the page displayed in a browser on the device.

11. The machine-readable of claim 7 wherein the user input comprises session data from a session process on the device.

12. The machine-readable of claim 7 further comprising:
transmitting a menu to the device, the menu comprising a plurality of choices; and
displaying the menu on the device; the input comprising a selection of at least one of the plurality of choices.

13. A system for interacting with a user comprising:
a device configured to receive an input and present a video stream and an audio stream;
a server coupled to the device, the server being configured to receive the input and transmit the video stream and the audio stream to the device;
a logic process coupled to receive the input, the logic process generating a text-based response based on the input;
a text-to-speech process configured to receive the text-based response and generate an audio stream of a voice-synthesized response based on the text-based response, the voice-synthesized response having a plurality of phonemes;
a video rendering process for generating a video stream based on the plurality of phonemes, the video stream comprising an animated head speaking the voice-synthesized response; and
a synchronization process for synchronizing the audio stream and the video stream.

14. The system of claim 13 wherein the video rendering process comprises morphing a plurality of predetermined shapes based on the plurality of phonemes.

15. The system of claim 13 wherein the logic process uses a rules-based system.

16. The system of claim 13 wherein the logic process uses a neural network.

17. The system of claim 13 wherein the logic process uses a natural language processor.

18. The system of claim 13 wherein the input comprises a user identity.

19. The system of claim 13 wherein the user input comprises session data from a session process on the device.

20. The system of claim 13 wherein the logic process generates a menu comprising a plurality of choices; the server transmitting the menu to the device, the device being configured to display the menu; the input comprising a selection of at least one of the plurality of choices.
